(19) United States
(12) Patent Application Publication
(10) Pub. No.: US 2007/0143223 A1
(43) Pub. Date: Jun. 21, 2007

(54) Caching information for kernel and boot components

(75) Inventors: Ajay Bhave, Redmond, WA (US); Andrey V. Lelikov, Redmond, WA (US); Caglar Gunyakti, Sammamish, WA (US); Ning Zhang, Sammamish, WA (US); Wen-Pin Scott Hsu, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/305,640

(22) Filed: Dec. 16, 2005

(51) Int. Cl. G06Q 99/00

(52) U.S. Cl. 705/59

(57) ABSTRACT

A cache is provided that stores licensing policies and information for components. The cache is available early in the boot cycle, such as during initialization and startup of the operating system, for use by the kernel and early boot components. Kernel and early boot components can then call a kernel application programming interface (API) to query the policy values. The policy values are read from a registry value into memory very early in the boot sequence. Using the kernel cache, the system may be started with proper licensable limits.

### BACKGROUND

Kernel and some kernel boot drivers need licensing information including licensing policies as early as phase0 initialization of kernel. Examples are maximum number of licensed processors, maximum memory amount, etc. Conventionally, licensing information is hard coded into components for the kernel and components that are booted early in the initialization process. In other words, kernel defaults are hard coded into the code. The licensing information dictates what the kernel and early boot components can do. Because the licensing information is hard coded, it is generally unchangeable and inflexible. It would be desirable for the licensing information to be changeable and flexible.

### SUMMARY

A cache is provided that stores licensing policies and information for components. The cache is available during initialization and startup of the operating system, for use by the kernel and early boot components (e.g., encrypted file system (EFS), video drivers, audio drivers, etc.). Kernel and early boot components can then call a kernel application programming interface (API) to query the policy values. The policy values are read from a registry value into memory very early in the boot sequence. Using the kernel cache, the system may be started with proper licensable limits.

The cache is created during the build process and written into the registry to help get the system booted. Once system is running, the kernel cache may be created or re-created. During runtime, the information is put into the kernel memory. When the system is shut down, the information in the kernel memory is lost. However, the information is also cached in the registry, so it is available during a subsequent boot. On subsequent reboots, the most up-to-date cache is in place for kernel components to query.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example computing environment in which example embodiments and aspects may be implemented.

FIG. 2 is a block diagram of an architecture in which a system uses a cache that stores licensing policies and is available early in the boot cycle.

FIG. 3 is a flow diagram of an example method using a cache that stores licensing policies and is available early in the boot cycle.

FIG. 4 is a flow diagram of an example method in which a kernel API may be used by an application.

FIG. 5 is a flow diagram of an example licensing policy method.

FIG. 6 is a flow diagram of an example method of tamper detection.

FIG. 7 is a flow diagram of an example method of notification.

### DETAILED DESCRIPTION

A cache is provided that stores licensing policies and information for components. The cache is centrally located and contains the information that globally dictates how components should behave. The cache is available early in the boot cycle, such as during initialization and startup of the operating system, for use by the kernel and early boot components. Kernel and early boot components can then call a kernel API to query the policy values. The policy values are read from a registry value into memory very early in the boot sequence. Using the kernel cache, the system may be started with proper licensable limits.

Exemplary Computing Arrangement

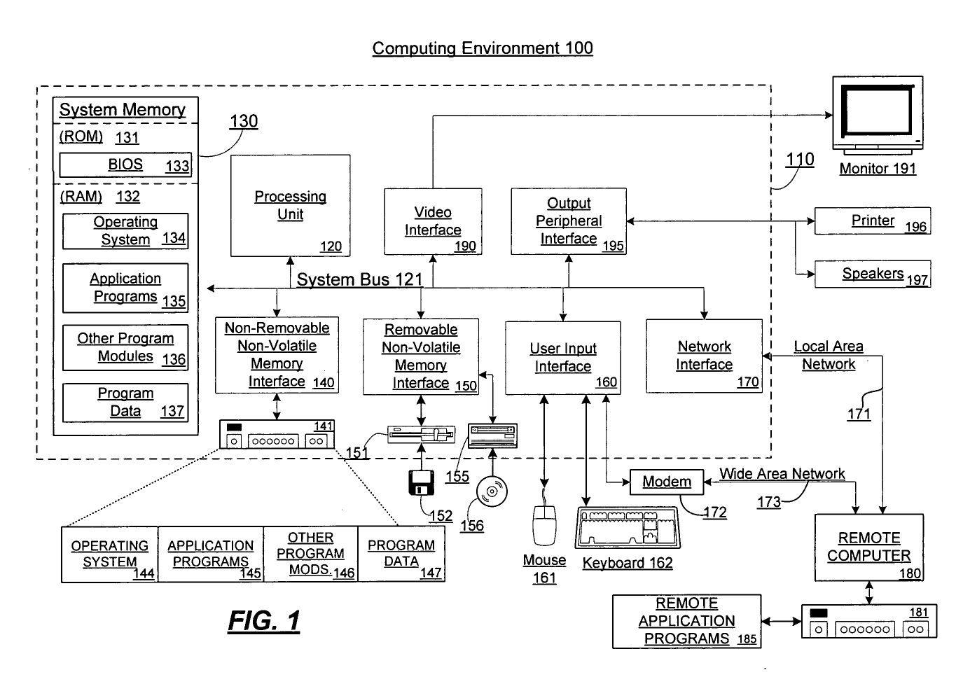

FIG. 1 shows an exemplary computing environment in which example embodiments and aspects may be implemented. The computing system environment 100 is only one example of a suitable computing environment and is not intended to suggest any limitation as to the scope of use or functionality. Neither should the computing environment 100 be interpreted as having any dependency or requirement relating to any one or combination of components illustrated in the exemplary operating environment 100.

Numerous other general purpose or special purpose computing system environments or configurations may be used. Examples of well known computing systems, environments, and/or configurations that may be suitable for use include, but are not limited to, personal computers, server computers, hand-held or laptop devices, multiprocessor systems, microprocessor-based systems, set top boxes, programmable consumer electronics, network PCs, minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 1, an exemplary system includes a general purpose computing device in the form of a computer 110. Components of computer 110 may include, but are not limited to, a processing unit 120, a system memory 130, and a system bus 121 that couples various system components including the system memory to the processing unit 120. The processing unit 120 may represent multiple logical processing units such as those supported on a multi-threaded processor. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus). The system bus 121 may also be implemented as a point-to-point connection, switching fabric, or the like, among the communicating devices.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Cache with Licensing Data

A licensing policy cache is a cache comprising software licensing policy values that resides in kernel memory. Kernel components, and other early boot components, may query policy values in this cache via a callable interface, e.g., an application programming interface (API), such as a QueryLicensingPolicyValue API, described further herein. A kernel cache registry is a copy of the latest version of the licensing policy cache that is stored in the protected registry. This is used to populate the licensing policy cache at boot time. Software licensing kernel code is code that resides in the kernel to manage the licensing policy cache and licensing policy queries, for example.

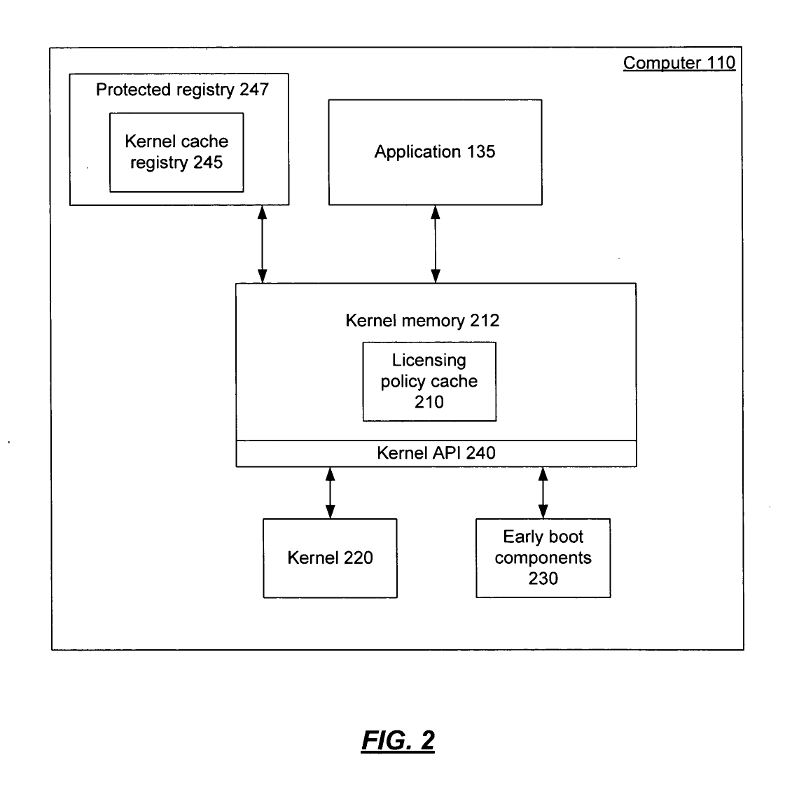

FIG. 2 shows an example system that provides a licensing policy cache 210 that stores licensing policies and information for components. Improved performance for user-mode components may be achieved by obtaining licensing values directly from the licensing policy cache 210 in kernel memory 212 via a system call. The cache 210 operates inside of computer 110 (shown in FIG. 1, for example). The cache 210 is available early in the boot cycle for use by the kernel 220 and early boot components 230. The kernel 220 and early boot components 230 can call a kernel API 240, for example, to query policy values (e.g., license files) from the cache 210. A kernel cache registry 245 is a copy of the latest version of the licensing policy cache 210 that is stored in the protected registry 247.

License files may be, for example, eXtensible Rights Markup Language (XrML) files that specify rights to software and may specify various types of conditions on the exercise of those rights. XrML is a type of XML whose syntax is specifically designed to describe rights and policies for digital goods. Thus, the policy values provide proper licensable limits, for example.

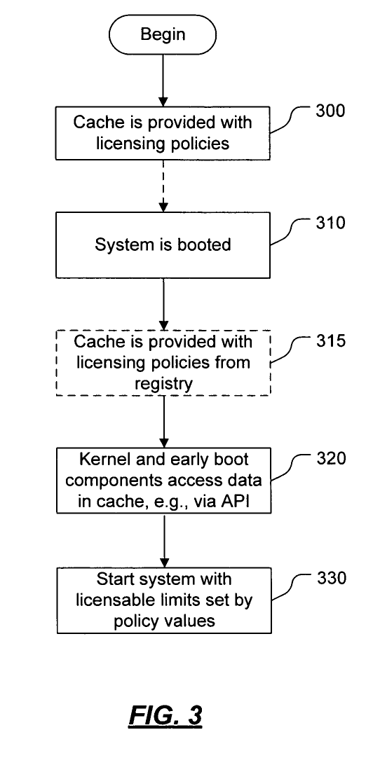

A flow diagram of an example method using the cache 210 is shown in FIG. 3. At step 300, a cache is provided with data comprising licensing policies and information for the kernel and early boot components. At some point, at step 310, the system is booted up. It is contemplated that the cache may also be provided with the licensing policies and information very early in the boot sequence, e.g., by being read from a registry value at step 315. Policies may be stored in sorted order, and retrieved using a binary search, for example, for performance. It is contemplated that when a software product gets built (e.g., by a software company), licensing policies for the software product may be assembled by a separate process and populated to protected registry. This information helps the first boot of the application. XrML license generation may be part of this process.

During initialization and startup of the operating system, at step 320, the kernel and early boot components access the data in the cache, e.g., to retrieve policy information. Kernel mode components may query licensing information directly from the kernel cache via a call. For example, kernel and early boot components may call a kernel API to query the policy values in the cache. The system is then started with the licensable limits set by the policy values in the cache, at step 330.

Desirably, the cache is created during the build process and written into the registry to help get the system booted. Once the system is running, the kernel cache may be created or re-created. During runtime, the information is put into the kernel memory. When the system is shut down, the information in the kernel memory is lost. However, the information is also cached in the registry, so it is available during a subsequent boot. On subsequent reboots, the most up-to-date cache is in place for kernel components to query.

Whenever new licenses are installed, the entire cache may be re-calculated. If the system is booted, any new licensing values as a result of new licenses desirably will be available to kernel and early boot components.

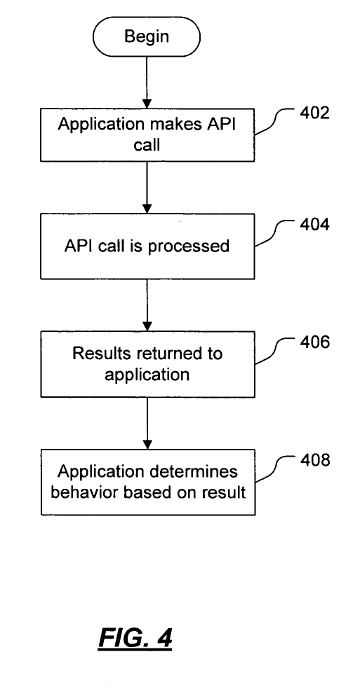

An API 240 is exposed that allows application software (such as application 135) to query the policy values that have been read from a registry value into memory very early in the boot sequence. The manner in which a kernel API, such as kernel API 240, may be used by an application is described with reference to FIG. 4. Initially, the application makes an API call at step 402. The API call is processed at step 404, and returns the results of the API call to the application at step 406. For example, an API call may request to retrieve license or policy information about a component from a cache, such as cache 210. The application then receives the result of the API call, and determines, based on that result, what the component's behavior should be, at step 408. Thus, the component's behavior may be flexible, by modifying the data in the cache, for example. Moreover, the kernel, kernel mode drivers, and early boot components may call a kernel API and behave according to the licensed values even during early boot cycle.

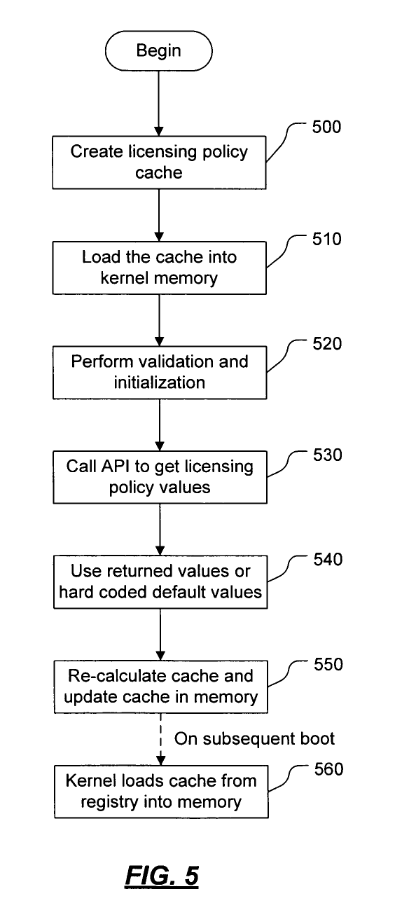

FIG. 5 is a flow diagram of an example licensing policy method. According to an embodiment, the licensing policy cache is initially created in the build process and injected into the unassembled builds, at step 500. The initial cache is not an exact policy cache but an approximate one that contains only the overridden policies. Very early in the kernel boot process, at step 510, the kernel loader loads the cache from the system into the kernel memory area in the INIT segment. Later in the kernel initialization sequence, at step 520, a kernel function to initialize licensing data is called to load the cache and perform validation and initialization. When the kernel needs to query licensing policies during boot, it calls an API, such as the QueryLicensingPolicyValue API, to get the values, at step 530. If kernel licensing policies do not exist, an appropriate error code is returned and the kernel may use the hard coded default values, at step 540. After the system has been started, the entire cache is desirably re-calculated and the cache in kernel memory is updated (this also updates the registry value for next boot), at step 550. On any subsequent boot, at step 560, the kernel will desirably load the full cache from registry into memory and the policy values will available by calling an API (e.g., QueryLicensingPolicyValue).

An example QueryLicensingPolicyValue API is provided as:

(

If (LicensingSystemNotInitialized)

Use data read from registry during INIT phase

else

Use memory-mapped section

ParseDataAndFindRequestedPolicy;
return Status code

)

To update the data in the policy cache, an update policy cache API may be called, which then calls an update license data API to perform the cache update. To update license data, an API such as UpdateLicenseData may be used:

(

VerifyLicensingData
CreateMemoryMappedSectionForData
If (PreviousSectionExists)

DeletePreviousMemoryMappedSection

return Status code

)

Kernel APIs facilitate kernel componentization by enabling kernel components to query the kernel licensing policies. The components of an operating system may query licensing information by using an API, for example. The APIs may be built into the kernel. Kernel and kernel drivers are componentized along with user mode components. The same concept may be applied to the kernel model components. Kernel mode components and kernel mode drivers desirably have means to query licensing policies.

Examples of the impacted kernel licensing policies include changing the maximum number of processors, the maximum available memory, and enabling or disabling kernel-mode features such as encrypted file system or dynamic volumes support.

Example settings that describe the kernel configuration in the registry that are conventionally fixed may be included in the kernel policy cache. Among these are:
[SYSTEM\CurrentControlSet\Control\Session Manager\RegisteredProcessors]
This contains the maximum processor count. This value is used during kernel initialization and determines the actual count of processors. Kernel enforces this value to be less then the value of LicensedProcessors.
[SYSTEM\CurrentControlSet\Control\Session Manager\LicensedProcessors]
It contains the maximum value for RegisteredProcessors.
[SYSTEM\CurrentControlSet\Control\ProductOptions\ProductType]
This contains the system product type.
[SYSTEM\CurrentControlSet\Control\ProductOptions\ProductSuite]
This holds information about the product suite.
[SYSTEM\CurrentControlSet\Control\TerminalServer\TSEnabled]
[SYSTEM\CurrentControlSet\Control\TerminalServer\TSAppCompat]
These values are used to make additional checking against SuiteMask.
[SYSTEM\Setup\SystemPrefix]
This value is used to check tampering with other values.

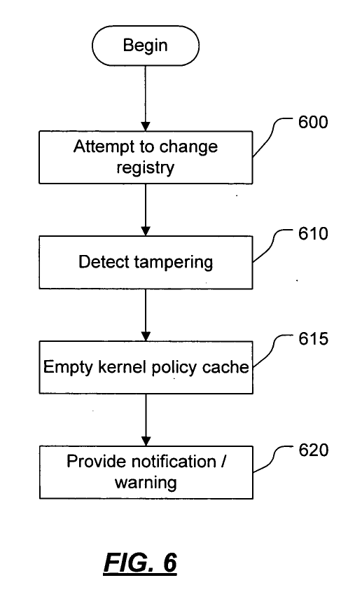

It is desirable to prevent users from modifying the contents of the kernel memory cache, and to notify a user if a tamper condition is detected. Kernel cache protection is provided against tampering. FIG. 6 is a flow diagram of an example method of tamper detection. If one tries to change the registry at step 600, e.g., to make the kernel think it is running on a different level, the tampering is detected at step 610, and a warning may be provided at step 620.

Additionally, in an embodiment, tamper conditions should result in the kernel code emptying the kernel policy cache, at step 615. The kernel cache registry is desirably not written in response to a tamper; only the in memory kernel policy cache should be emptied. This allows queries at the next boot and components to receive the same policy values that they would have if the system were properly shutdown prior to the tamper.

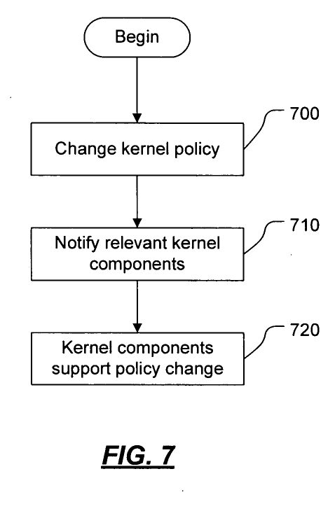

Notification is provided to the operating system kernel component of changes to policy values. FIG. 7 is a flow diagram of an example method of notification. When a kernel policy has changed at step 700, the interested kernel components may be notified that a change has been made to kernel policy at step 710. The kernel code will notify kernel components of changes. Kernel components can then do whatever is desired to support policy change at step 720. For example, a cryptographic hash of a licensing policy cache may be stored redundantly by a secure process. When an application queries a licensing policy value, the calculated value is compared to the previously stored copy. If there is a mismatch, tampering notification may be sent to system components, for example. The system components may change their runtime behavior because their licensing information has become untrusted.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A licensing policy method for a kernel or early boot component, comprising:
retrieving a licensing policy for a kernel or early boot component from a cache; and
setting a licensable limit for the kernel or early boot component based on the licensing policy.

2. The method of claim 1, further comprising providing the cache with the licensing policy prior to retrieving the licensing policy.

3. The method of claim 2, wherein providing the cache with the licensing policy comprises receiving the licensing policy from a registry.

4. The method of claim 3, further comprising assembling the licensing policy and populating the licensing policy to the registry.

5. The method of claim 1, wherein retrieving the licensing policy from the cache comprises accessing the data via a callable interface.

6. The method of claim 1, further comprising setting the licensing policy to a hard coded default value if the cache does not contain the licensing policy for the kernel or early boot component.

7. The method of claim 1, further comprising providing the kernel or early boot component with the licensing policy.

8. The method of claim 1, further comprising detecting tampering and providing a notification regarding the tampering.

9. The method of claim 1, further comprising changing a licensing policy and notifying an affected component.

10. A licensing policy system, comprising:
a cache comprising a licensing policy for a kernel or early boot component; and
a callable interface for accessing the licensing policy in the cache.

11. The system of claim 10, further comprising a kernel memory which comprises the cache.

12. The system of claim 10, further comprising a kernel cache registry comprising a copy of the cache.

13. The system of claim 10, wherein the cache is available early in a boot cycle for the kernel or early boot component.

14. The system of claim 10, wherein the callable interface comprises a method to query the cache for the licensing policy.

15. The system of claim 10, further comprising an application for receiving the licensing policy and setting a licensable limit for the kernel or early boot component based on the licensing policy.

16. The system of claim 10, wherein the licensing policy is set to a hard coded default value.

17. A computer-readable medium having stored thereon a data structure, comprising:
a first data field containing data representing a kernel memory; and
a second data field containing data representing a licensing policy cache.

18. The computer-readable medium of claim 17, wherein the licensing policy cache comprises data representing a licensing policy for a kernel or early boot component.

19. The computer-readable medium of claim 17, wherein the licensing policy cache is populated with data from a registry.

20. The computer-readable medium of claim 17, wherein the licensing policy cache is emptied upon detection of tampering.
